(19) United States
(12) Patent Application Publication
(10) Pub. No.: US 2025/0206061 A1
(43) Pub. Date: Jun. 26, 2025

(54) METHOD OF PERFORMING ZONE ABLATION ON A POLYMER SUBSTRATE

(71) Applicant: Magna Exteriors Inc., Aurora (CA)

(72) Inventors: Daniel VANDER SLUIS, Rochester Hills, MI (US); Mark T. Pilette, Oxford, MI (US); Benjamin J. Barber, Leonard, MI (US)

(73) Assignee: Magna Exteriors Inc., Aurora, ON (CA)

(21) Appl. No.: 18/844,946

(22) PCT Filed: May 25, 2023
(86) PCT No.: PCT/US2023/023479

§ 371 Date: Sep. 7, 2024

Related U.S. Application Data
(60) Provisional application No. 63/347,714, filed on Jun. 1, 2022.

(51) Int. Cl. B44C 1/22; B44C 3/00; B44F 1/06; B60R 13/04

(52) U.S. Cl. CPC B44C 1/228; B44C 3/005; B44F 1/06; B60R 13/04

(57) ABSTRACT

A vehicle panel arrangement that has a first appearance during the daylight but is capable of being backlight in a dark environment causing the badge to have a second appearance as light is transmitted through micro-apertures formed through the vehicle panel arrangement. The vehicle panel arrangement is such that the micro-apertures a not visible in the first appearance due to their small size, which is created using laser ablation, screen printing or digital printing techniques.

### FIELD OF THE INVENTION

The present invention relates to a method or performing zone ablation on a polymer substrate, which has been painted with either grayscale paint layers or color paint layers.

### BACKGROUND OF THE INVENTION

In the field of automotive design improvements in lighting units have made it possible to expand the aesthetics of the automobile. One area where improvements are possible is on the visual surfaces of vehicle panels. In particular it is desirable to provide a panel that when viewed in daylight looks like a typical non-illuminated painted surface, but in a dark environment the panel is connected to a light unit that illuminates the panel. Another area of expanding automobile aesthetics involves the formation of large graphics on painted polymer substrates, which can be colored a different color or optionally be backlit. Forming large graphics on painted polymer substrates using laser ablation is challenging because the substrate can be damaged by the light during the laser ablation process.

### SUMMARY OF THE INVENTION

Another embodiment of the present invention is directed to a vehicle panel arrangement that has a body formed of polymer substrate, which is typically a transparent polymer substrate. The body includes a painted side and a viewing side. There is a sacrificial material layer adjacent to the body on at least a portion of the painted side. Also included is at least one base paint layer applied over the sacrificial material layer. The vehicle panel arrangement includes a plurality of apertures through the at least one base paint layer and at least a portion of the sacrificial material layer. Each of the apertures form a blind hole terminating at the portion of the sacrificial material layer and the body. The apertures are formed using ablation techniques described herein. During the ablation process the sacrificial material layer protects the body from damage during the formation of the plurality of apertures. The plurality of apertures are formed with a desired shape or specific pattern and provide a desired aesthetic to the vehicle panel.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic cross-sectional elevational view of a portion of a badge arrangement according to one embodiment of the invention.

FIG. 2 has several schematic cross-sectional elevational views of the badge arrangement according to several embodiments of the invention.

FIG. 3A is a schematic cross-sectional elevational view of a badge arrangement according to a second embodiment of the invention.

FIG. 3B is an enlarged schematic cross-sectional elevational view of the badge arrangement of FIG. 3A.

FIG. 4 is a schematic diagram showing a method of forming a badge arrangement using laser ablation.

FIG. 5 is a front perspective view of a vehicle having a vehicle panel arrangement specifically as a backlit badge arrangement.

FIG. 6 is a partial side perspective view of a vehicle with a vehicle panel arrangement on the front fender of the vehicle.

FIG. 7 is a schematic cross-sectional elevational view of a portion of the vehicle panel arrangement.

FIG. 8 is an enlarged view of one of the micro-apertures of FIG. 7.

FIG. 9 is a schematic diagram showing a painted polymer substrate, painted using a grayscale paint, which has been formed using zone ablation according to a method of the present invention.

FIG. 10 is a schematic diagram showing a painted polymer substrate, painted using a color paint, which has been formed using zone ablation according to a method of the present invention.

FIG. 11 is a cross-sectional side view of a vehicle panel arrangement according to another embodiment of the invention.

FIG. 12 is an enlarged cross-sectional side view of an aperture shown in FIG. 11.

### DETAILED DESCRIPTION OF THE PREFERRED EMBODIMENTS

The following description of the preferred embodiments is merely exemplary in nature and is in no way intended to limit the invention, its application, or uses.

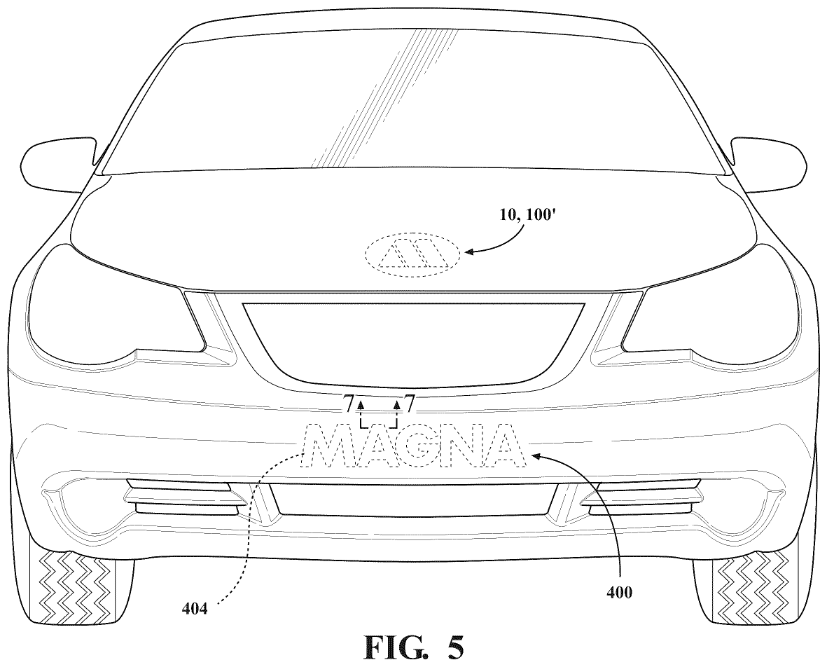

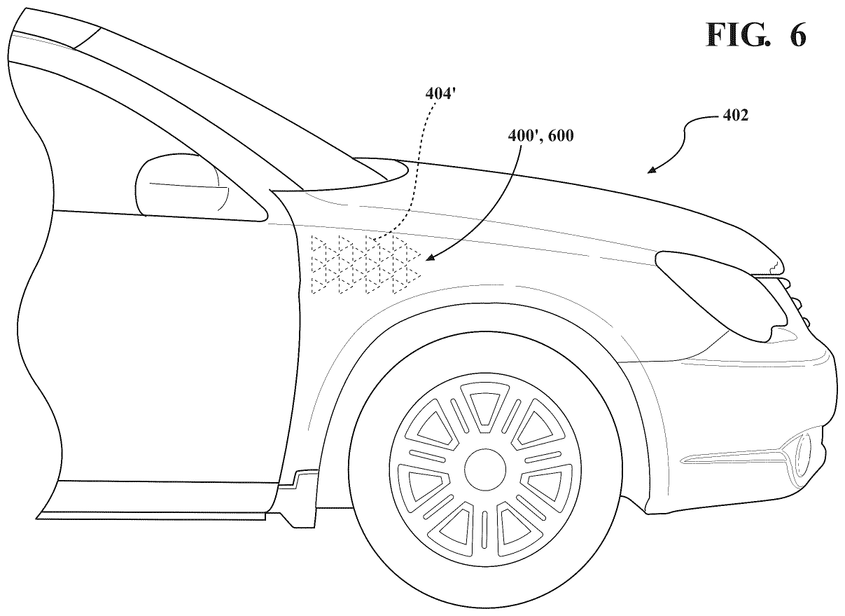

Referring now to FIGS. 5 and 6 a vehicle panel arrangement 400, 400′ shown as part of a vehicle 402. The vehicle panel arrangement 400 is part of a front fascia, while vehicle panel arrangement 400′ shown in FIG. 6 is a front fender of the vehicle 402. It is within the scope of this invention for the vehicle panel arrangement to be part of any vehicle surface where backlit illumination is desired. The vehicle panel arrangement 400, 400′ and has an illumination surface 404, 404′ that can be backlit by a light source (described below). The illumination surface 404 of the vehicle panel arrangement 400 shows letters when illuminated but is not visible when the light source is turned off. Illumination surface 404′ of vehicle panel arrangement 400′ shows a pattern when illuminated but is not visible when the light source is turned off. FIG. 5 also shows a vehicle panel arrangement that is specifically a badge arrangement 10, 100. The badge arrangement 10, 100 is a type of vehicle panel arrangement, but differs from the vehicle panel arrangement 400, 400′ in that they are emblems or ornaments connected to surface on the vehicle exterior or interior. Also, the construction of the vehicle panel arrangement 400, 400′ can differ slightly from the construction of the badge arrangement 10, 100.

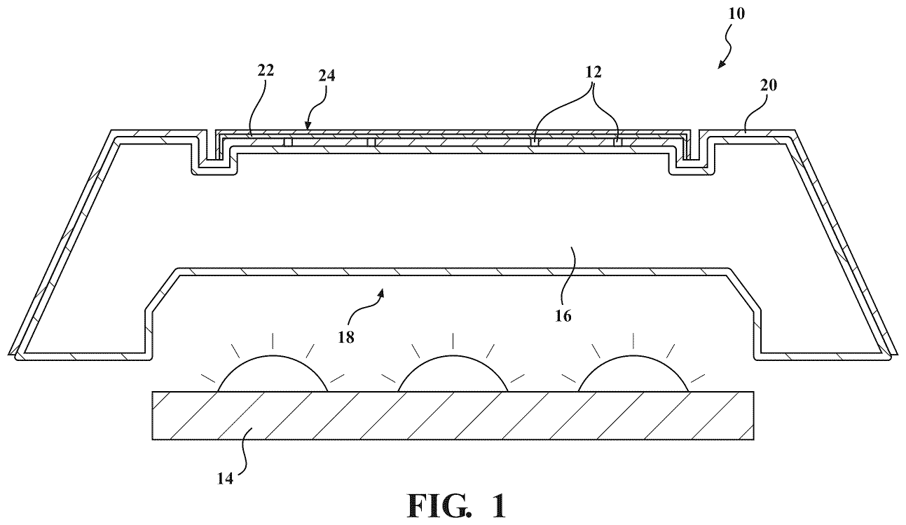

Referring now to FIG. 1 the badge arrangement 10 is shown having a plurality of micro-apertures 12 forming a light pattern suitable for being backlit by a light source 14. The badge arrangement 10 includes a body 16 having a light receiving surface side 18 that receives light from the light source 14. The light source 14 is singular or plural and is any type of light source including, but not limited to an incandescent bulb, light emitting diode and organic light emitting diode.

The body 16 is formed from polymer material that is transparent or semi-transparent and allows the light from the light source to pass through the body 16. Connected to the body 16 is a metalized film layer 20 that is light transmissible. A masking layer 22 connects to a portion of the metallized film layer 20. The masking layer 22 blocks the light transmitting through the metallized film layer 20 from passing through the masking layer 22. The masking layer 22 is made of any type of opaque material and can be an opaque paint film or paint layer that is applied to the metalized film layer 20.

The badge arrangement 10 further includes an argent color layer 24 connected to a portion of the masking layer 22. The argent color layer 24 is a layer of paint or paint film that has argent color properties. Argent as used herein includes colors that have a metallic look and are somewhat reflective, which helps conceal the micro-apertures 12.

The badge arrangement 10 further includes a plurality of micro-apertures 12 extending through the argent color layer 24 and the masking layer 22. Light from the light source 14 is able to transmit through the body 16, metallized film layer 20 and the plurality of micro-apertures 12. The light is blocked from transmitting through the masking layer 22. The plurality of micro-apertures 12 each have a certain diameter that is generally between 30 microns to 80 microns in diameter. It is also within the scope of this invention for the micro-apertures 12 to be less than or equal to 60 microns in diameter or greater than or equal to 60 microns in diameter all depending on the needs of a particular application. The spacing of the micro-apertures 12 is referred to as the pitch which is the distance between the center of a first one of the plurality of micro-apertures and the center of an a second one of the plurality of micro-apertures. The pitch in one embodiment of the invention is 300 microns between each of the micro-apertures 12.

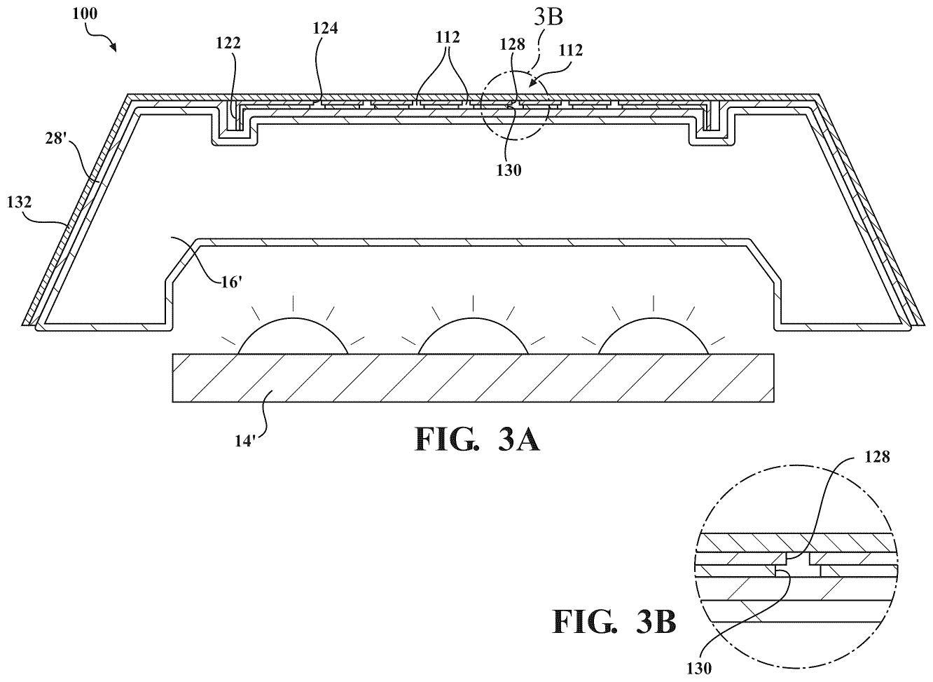

Referring now to FIGS. 3A and 3B there is the badge arrangement 100 that is formed with micro-apertures 112 that have a unique formation. This embodiment has a light sources 14′, which has one or more light emitting sources, a body 16 and metalized film layer 20′. In this embodiment a masking layer 122, and argent color layer 124 are applied using digital printing or screen printing, sometimes called silk screen printing, which are applied in successive steps. Laser ablation is not used to form the micro-apertures, instead micro-apertures 112 are formed by during the printing of the masking layer 122 and the argent color layer 124. Each micro-aperture 112 includes an argent color layer aperture 128 formed through the argent color layer 124 and aligned with a masking layer aperture 130 formed through the masking layer 122. It can be difficult to align the making layer aperture 130 and the argent color layer aperture 128. The masking layer aperture 130 has a larger diameter than the argent color layer aperture 128. This accounts for possible printing errors or misalignments between the masking layer aperture 130 and the argent color layer aperture 128.

In another embodiment of the invention the badge arrangement 10, 100 further includes a lens 32, 132 connected over the body 16, 16′, metalized film layer 20, 20′ masking layer 22, 122 and argent color layer 24, 124. The lens 32, 132 can be made of any material as long as it is light transmissible. The lens 32, 132 can be a separately molded piece that is connected or can be a layer of material that is sprayed onto the badge arrangement 10, 100. In one embodiment the lens 32, 132 is made of a self-leveling polymer. The lens 32, 132 can also be made polyurethane. The lens 32, 132 can also be constructed to be able to magnify the at least a portion of the argent color layer 24, 124 when viewed from a viewing surface of the lens 32, 132. In another aspect of the invention the lens 32, 132 is constructed to be able to minimize the at least a portion of the argent color layer 24, 124 when viewed from a viewing surface of the lens 32, 132.

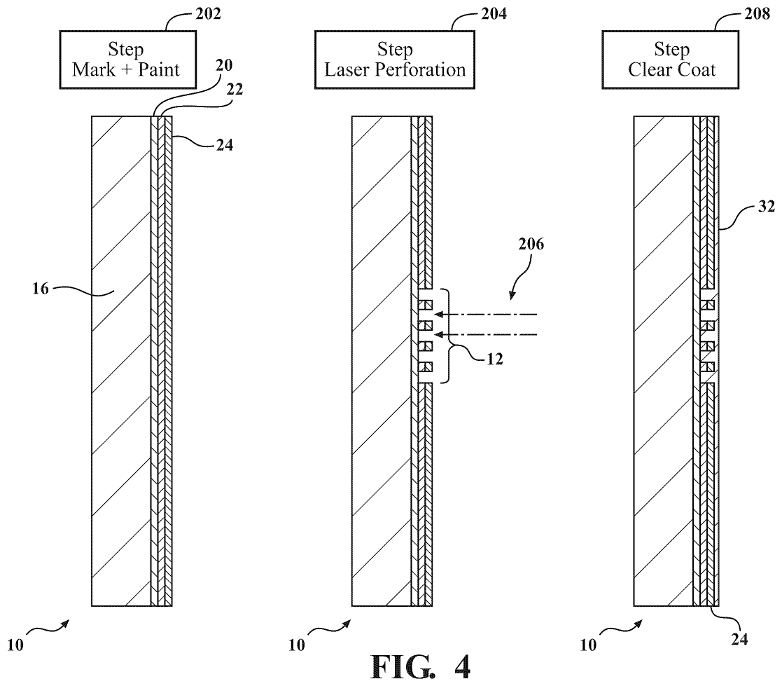

Referring now to FIG. 4, a schematic diagram showing a method 200 of forming the badge arrangement 10 using laser ablation is shown. The first step 202 involves providing the body 16 with the metalized film layer 20, masking layer 22, argent color layer 24 applied in layers on to the body 16. At a step 204 laser beams 206 are projected at and ablate portions of the argent floor layer 14 and masking layer 22 for form the micro-apertures 12 at desired locations. At a step, a layer of clear coating material, such as polyurethane is applied to the surface to form the lens 32. The lens 32 covers the micro-apertures 12 the argent floor layer with the masking layer 22, metalized film layer 20 and body 16 underneath. In areas where the body 16 and metalized film layer 20 are only exposed the lens 32 is formed over the metalized film layer 20.

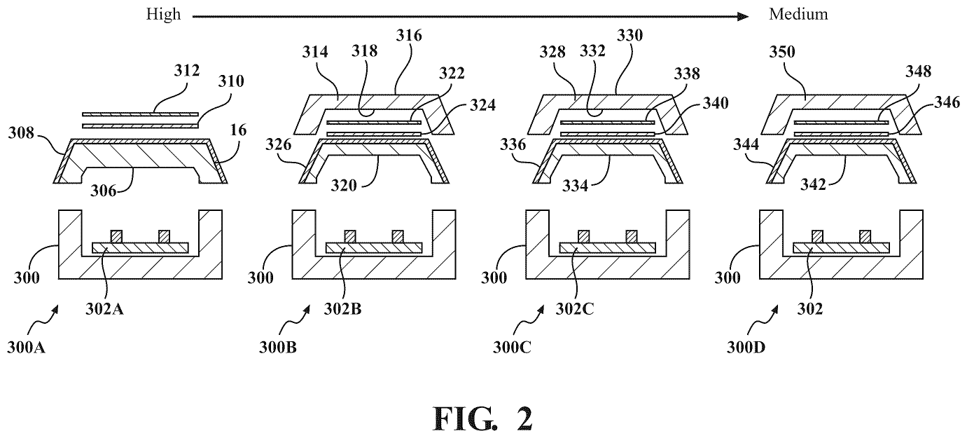

FIG. 2 has several schematic cross-sectional elevational views of the badge arrangement according to several embodiments of the invention. In each embodiment of the invention there is a connection surface 300A, 300B, 300C, 300D and light source 302A, 302B, 302C, 302D connected to the connection surface 300.

According to one embodiment an automotive assembly construction 304A there is a body 306 with a metalized layer 308 applied to the show surface, which is called the A side of the body 306. The metalized layer 308 is applied using vapor deposition or some other suitable method including applying a film layer. Light from the light source 302 is able to pass through the metalized layer 308. An opaque masking layer 310 is applied over a portion of the metalized layer 308. The opaque masking layer 310 in one embodiment is a layer of black paint or black paint film, however any suitable opaque material is within the scope of the invention. Over a portion of the opaque masking layer 310 is an argent color layer 312. The argent color layer 312 can be liquid paint applied by spraying or brushing, or the argent color layer can be a layer of paint film. Laser ablation is then used to create micro-apertures in the same manner as the micro-apertures 12 are formed in FIG. 4 described above. The laser is used to create holes through the argent color layer 312 and the opaque masking layer 310.

The automotive assembly construction 300B has a lens 314 with a show side 316, also called an A side, and a back side 318 that is called a B side. The lens 314 is a clear material that is connected to a body 320 and is formed if a clear transparent material, such as polyurethane or polyacrylic. The body 320 has a metalized layer 326 applied to the exterior surface. Some light is able to pass through the metalized layer 326. The back side 318 of the lens 314 is first coated with an argent color layer 322, followed by an opaque material layer 324. The opaque material 324 and the argent color layer 322 are then ablated using a laser that directs light toward the back side 318 of the lens 314 and creates micro-apertures similar to micro-apertures 12 in the embodiments described above. After ablation, the lens 314 is then connected to the body 320.

The automotive assembly construction 300C has a lens 328 with a show side 330, also called an A side, and a back side 332 that is called a B side. The lens 328 is a polyurethane lens having a magnification between the back side 332 and the show side 330, which allows for the micro-apertures formed to be smaller and less noticeable. The lens 328 is a clear material and is connected to a body 334. The body 334 has a metalized layer 336 applied to the exterior surface. Some light is able to pass through the metalized layer 336. The back side 332 of the lens 328 is first coated with an argent color layer 338, followed by an opaque material layer 340. The opaque material 340 and the argent color layer 338 are then ablated using a laser that directs light toward the back side 332 of the lens 328 and creates micro-apertures similar to micro-apertures 12 in the embodiments described above. After ablation, the lens 328 is then connected to the body 334.

The automotive assembly construction 304D is different from the above three automotive assemblies in that it utilizes printing to create the micro-apertures rather than ablation. There is a body 342 with a metalized layer 344 applied to the show surface, which is called the A side of the body 342. The metalized layer 344 is applied using vapor deposition or other suitable methods. Light from the light source 302 is able to pass through the metalized layer 344. An opaque masking layer 346 is applied over a portion of the metalized layer 344. The opaque masking layer 346 in one embodiment is a layer of black paint or black paint film, however any suitable opaque material is within the scope of the invention. Over a portion of the opaque masking layer 346 is an argent color layer 348. The argent color layer 348 can be liquid paint applied by spraying or brushing, or the argent color layer can be a layer of paint film. In this embodiment the opaque masking layer 346 and the argent color layer 348 are applied using a printer that prints a pattern on the surface of the body 342. Micro apertures are printed and aligned as each layer is printed. This eliminates the need for laser ablation and also saves costs by reducing equipment and energy used. Light from the light source 302 passes through the body 334, the metalized layer 336 and the micro-apertures to illuminate the automotive assembly construction 304D. A lens 350 that is formed from polyurethane, polyacrylic or other suitable material is applied over the exposed portions of the body 342, metalized layer 344, opaque masking layer 346 and argent color layer 348 to provide protection to the layers underneath and to provide a smooth finish.

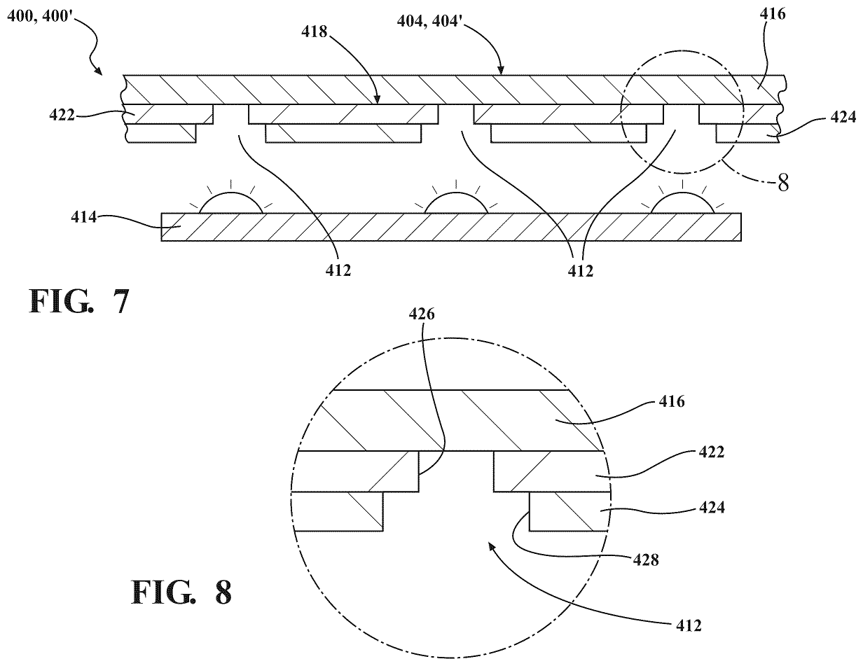

Referring now to FIG. 7, a cross-sectional side view of the vehicle panel arrangement 400, 400′ is shown. The vehicle panel arrangement 400, 400′ has a plurality of micro-apertures 412 forming a light pattern suitable for being backlit by a light source 414. The vehicle panel arrangement 400, 400′ includes a body 416 having a light receiving surface side 418 that receives light from a light source 414 and the illumination surface 404, 404′. The light source 414 is singular or plural and is any type of light source including, but not limited to an incandescent bulb, light emitting diode and organic light emitting diode.

The body 416 is formed from polymer material that is transparent or semi-transparent and allows the light from the light source to pass through the body 416 and be emitted from the illumination surface 404, 404′. A color layer 422 is applied to the light receiving surface side 418. The color layer 422 is a layer or paint or paint films that is visible from the illumination surface 404, 404′. The color layer is optionally light transmissible. A masking layer 424 connects to all of or a portion of the color layer 422.

The masking layer 424 blocks light from transmitting through the color layer 422. The masking layer 424 is made of any type of opaque material and can be an opaque paint film or paint layer that is applied to the color layer 422.

The vehicle panel arrangement 400, 400′ further includes a plurality of micro-apertures 412 extending through the color layer 422 and the masking layer 424. Light from the light source 414 is able to transmit through the plurality of micro-apertures 412. The light is blocked from transmitting through the masking layer 424. The plurality of micro-apertures 412 each have a certain diameter that is generally between 30 microns to 80 microns in diameter. It is also within the scope of this invention for the micro-apertures 412 to be less than or equal to 60 microns in diameter or greater than or equal to 60 microns in diameter all depending on the needs of a particular application. The spacing of the micro-apertures 412 is referred to as the pitch which is the distance between the center of a first one of the plurality of micro-apertures and the center of an a second one of the plurality of micro-apertures. The pitch in one embodiment of the invention is 300 microns between each of the micro-apertures 412.

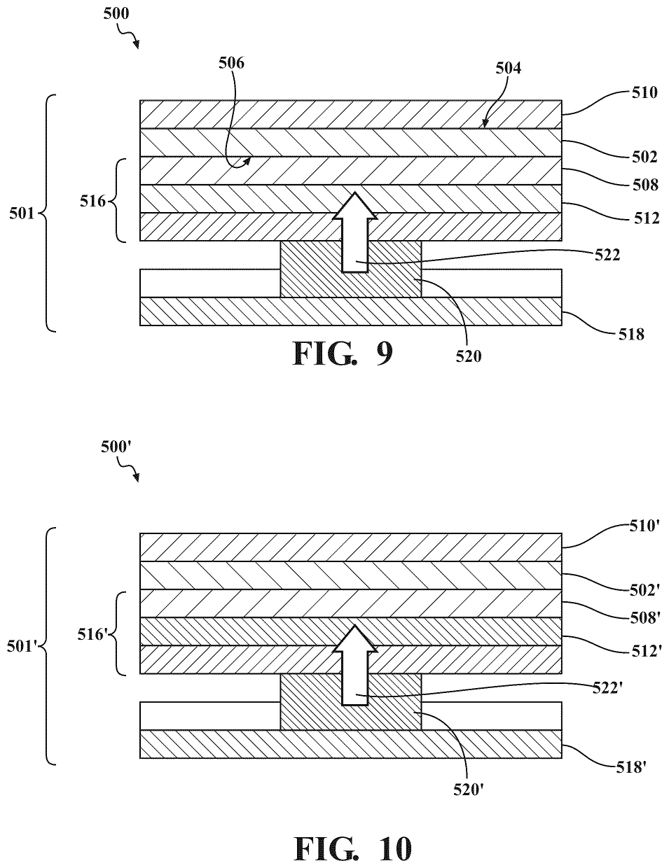

The micro-apertures 412 in one embodiment are formed using laser ablation similar to the techniques described above. It is also within the scope of this invention for the color layer 422 and the masking layer 424 to be printed with apertures that align as shown in FIG. 8. FIG. 8 is an enlarged view of one of the micro-apertures 412 that is formed using printing. Each aperture 412 is formed by aligning a color layer aperture 426 and a masking layer aperture 428. Since the color layer 422 is printed first and the masking layer 424 is printed second, it is possible for the color layer aperture 426 and the making layer aperture 428 to become misaligned. In order to prevent misalignment, the color layer aperture 426 is smaller in diameter than the diameter of a masking layer aperture 428. The difference in diameters allow for a margin of error and make it easier for creating consistent looking micro-aperture 412. FIGS. 9 and 10 are schematic diagrams showing a finished article 501, 501′ which is formed by a number of material layers that will be described herein. The finished article 501, 501′ includes a polymer substrate 502, 502′, painted using grayscale paint as shown in FIG. 9 or a color paint as shown in FIG. 10; both of which have undergone zone ablation according to a method 500, 500′ of the present invention. The method 500, 500′ includes providing the polymer substrate 502, 502′ having an appearance side 504, 504′ and a painted side 506, 506′. The polymer substrate 502,502′ can be made of any type of transparent, semi-transparent or opaque polymer material. In a preferred embodiment of the invention the polymer substrate 502, 502′ is polycarbonate or poly(methyl methacrylate) (also referred to hereafter as PMMA). To the appearance side 504, 504′ of the polymer substrate an optional layer 510, 510′ of hard coat material is applied. The layer 510, 510′ of hard coat material is a type of material that protects the polymer substrate 502, 502′ and includes suitable known for hardness and durability, such as styrene maleic anhydride, silica or other suitable materials.

On the painted side 506, 506′ of the polymer substrate 502, 502′ is a sacrificial material layer 508, 508′. The sacrificial material layer 508, 508′ a transparent paint layer that protects the polymer substrate 502, 502′ from damage from the ablation light. The transparent paint layer can be formed with many types of paint. It is within the scope of this invention for the paint to be water based or solvent based. While a single layer is described within the scope of the invention for there to be multiple layers since it may be necessary to apply several coats or layers to achieve a desired thickness. The sacrificial material layer 508, 508′ is generally at least 9 microns in thickness, preferably at least about 10 microns in thickness, and ideally 10 microns in thickness.

Next the method 500, 500′ includes providing at least one base paint layer 512, 512′ onto the sacrificial material layer 508, 508′. While a single layer is described within the scope of the invention for there to be multiple layers since it may be necessary to apply several coats or layers to achieve a desired thickness. In the embodiment of the invention shown in FIG. 9, the base paint layer 512 is a shaded paint that is grayscale. For example, the base paint layer 212 is black, gray or white and is generally greater than about 12 microns thickness, preferably less than about 15 microns thickness or ideally 12 to 15 microns in thickness. The shaded paint can be formed with many types of paint. It is within the scope of this invention for the paint to be water based or solvent based. In the embodiment of the invention shown in FIG. 10 the base paint layer 512′ is a colored paint layer, which typically requires a greater thickness to provide sufficient color coverage. The base paint layer 512′ is generally greater than about 22 microns thickness, preferably less than about 28 microns thickness or ideally 22 to 28 microns in thickness.

The method 500, 500′ also includes applying a primer layer 514, 514′ to the painted side and providing an ablation zone 516, 516′ of the polymer substrate 502, 502′ that will be described in greater detail below. The primer layer 514, 514′ is a topcoat opaque paint layer that helps adhesion of a successively applied accent layer 518, 518′ to the finished article 501, 501′. The primer layer 514, 514′ is generally greater than about 15 microns thickness but can be less than or equal to 15 microns thickness or ideally about 15 microns in thickness. While a single layer is described within the scope of the invention for there to be multiple layers since it may be necessary to apply several coats or layers to achieve a desired thickness.

The method 500, 500′ includes providing a laser 520, 520′ for selectively emitting an ablation light 522,522′ onto the ablation zone 516, 516′ on the painted side 506,506′ of the polymer substrate 502, 502′. Next the method 500, 500′ includes operating the laser 520, 520′ to emit an ablation light 522, 522′ onto the ablation zone 516, 516′ and removing a base paint layer 512, 512′, primer layer 514, 514′ and a portion of the sacrificial material layer 508, 508′.

The ablation zone 516, 516′ is an area on the finished article 501, 501′ where it is desirable to remove the base paint layer 512, 512′, the primer layer 514, 514′ and a portion of the sacrificial material layer 508, 508′ using ablation light 522, 522′ to burn or remove the primer layer 514, 514′, the base paint layer 512, 512′ and a portion of the sacrificial material layer 508, 508′. Since the intensity of the ablation light 522, 522′ can damage the polymer substrate 502, 502′ the present invention's use of the sacrificial material layer 508, 508′ protects the polymer substrate 502, 502′ by providing a protective layer than can be ablated and prevents damage to the polymer substrate 502, 502′. The ablation zone 516, 516′ can have a certain design or pattern in order to form letters, logos or decorative patterns depending on the desired aesthetic.

The kind of ablation light 522, 522′ used will depend on many factors, with one main factor being the thickness of the base paint layer 512, 512′ and the primer layer 514, 514′. Also, the color of the different layers has a significant affect. The color is an important factor because the amount of energy required to remove layers in the ablation zone 516, 516′ can vary due to color, which changes the energy absorption in the ablation zone 516, 516′. As a result, the ablation light 522,522′ can have a different and specific wattage value, pule time, and wavelength depending on the color of the base paint layer 512, 512′, primer layer 514, 514′.

After operation, the laser 520, 520′ the accent layer 518, 518′ is applied onto the painted side 506, 506′ and ablation zone 516, 516′ of the polymer substrate 502, 502′. The accent layer is a color paint layer that can have any desired color of shade that will help to accent the ablation zone 516, 516′ to create the desired aesthetic look of the finished article 501, 501′. The accent layer can be formed with many types of paint. It is within the scope of this invention for the paint to be water based or solvent based. The accent layer is preferably a color paint but can be white or any color that would be in contrast to the base layer. The accent layer can be transparent, but does not need to be, however, a translucent level of 20% or higher is optimum in applications where backlighting is used. The accent layer 518, 518′ can be paint used to fill in or accent the ablation zone 516, 516′ or it can be an opaque layer that can then be backlit for a desired appearance. The accent layer 518, 518′ is generally greater than about 25 microns thickness, preferably less than about 30 microns thickness or ideally 25 to 30 microns in thickness. A single layer is described however it is within the scope of the invention for there to be multiple layers since it may be necessary to apply several coats or layers to achieve a desired thickness.

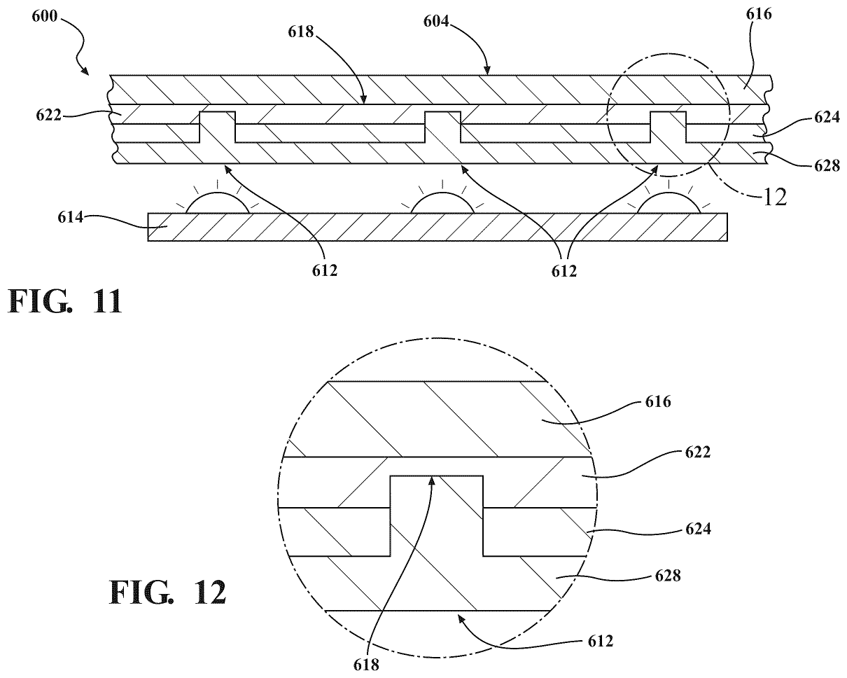

Referring now to FIGS. 11 and 12, a cross-sectional side view of the vehicle panel arrangement 600 is shown. The vehicle panel arrangement 600 is also shown in FIG. 6, can be used in place of vehicle panel arrangement 400′. The vehicle panel arrangement 600 has a plurality of apertures 612. In one embodiment the plurality of apertures 612 form a light pattern suitable for being backlit by a light source 614, which can be a light emitting diode, organic light emitting diode, incandescent light or any other suitable light source. The vehicle panel arrangement 600 includes a body 616 body formed of polymer substrate. The body 616 includes a painted side 618 that can receive light from the light source 614 and a viewing side 604.

The body 616 is formed from any suitable polymer material that is transparent or semi-transparent and allows the light from the light source to pass through the body 616 and be emitted from the viewing side 604. In one particular embodiment the body 616 is formed of polycarbonate. A sacrificial material layer 622 is applied to the painted side 618 of the body 616. The sacrificial material layer 622 is a layer of paint, preferably transparent paint that is visible from viewing side 604. The sacrificial material layer 622 is optionally light transmissible.

At least one base paint layer 624 is applied over the sacrificial material layer 622 and blocks light from transmitting through the sacrificial material layer 622. The base paint layer 624 is made of any type of opaque material and can be an opaque paint film or paint layer that is applied to the sacrificial material layer 622.

The vehicle panel arrangement 600 further includes a plurality of apertures 612 extending through the base paint layer 624 and a portion of the sacrificial material layer 622. The apertures 612 are formed using laser ablation and the sacrificial material layer 622 functions to protect the material of the body 616 from being damaged by the laser light during formation of the apertures 612. The apertures 612 can be arranged in a desired pattern in order to provide an aesthetic pattern on the vehicle panel arrangement 600. An accent layer 628 is applied over the base paint layer 624 and fills in the apertures 612, covering a portion of the sacrificial material layer 622 that is exposed in each of the apertures 612. The accent layer 622 protects the layers under it and prevents chipping of the layers in the apertures 612. The accent layer 622 in one embodiment is a layer of transparent material so that light from the light source 614 is able to transmit through the apertures 612 to illuminate the pattern formed in the vehicle panel arrangement 600. It is also possible for the accent layer 622 to be a semi-transparent paint that has a desired color that can be illuminated by the light source 614. In yet another embodiment of the invention the accent layer 622 is an opaque colored paint that is visible from the viewing side 604. This embodiment eliminates the need to have the light source 614 because the desired aesthetic does not involve back lighting the vehicle panel arrangement 600.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of performing zone ablation on a painted polymer substrate of a vehicle panel comprising the steps of:
providing a polymer substrate having an appearance side and a painted side;
providing a sacrificial material layer on the painted side of the polymer substrate;
providing at least one base paint layer onto the sacrificial material layer;
providing a laser for selectively emitting an ablation light onto an ablation zone on the painted side of the polymer substrate, and
operating the laser to emit the ablation light onto the ablation zone and remove the at least one paint layer and a portion of the sacrificial material layer to form one or a plurality of micro-apertures, wherein the sacrificial material layer protects the polymer substrate.

2. The method of claim 1 wherein the polymer substrate is polycarbonate.

3. The method of claim 1 wherein the sacrificial material layer is a transparent paint layer that protects the polymer substrate from damage from the ablation light.

4. The method of claim 1 further comprising:
wherein the at least one base paint layer has a color, and
wherein ablation light has a specific wattage value, a specific pulse and a specific wavelength that depends on the color of the at least one paint layer.

5. The method of claim 1 further comprising the steps of:
applying an accent paint layer onto the painted side and ablation zone of the polymer substrate.

6. The method of claim 5 further comprising the step of:
applying a primer layer to the painted side and the ablation zone of the polymer substrate prior to the step of operating the laser, wherein the primer layer enhances the adherence of the accent paint layer.

7. The method of claim 6 wherein the primer layer is less than or equal to 15 microns in thickness.

8. The method of claim 5 wherein the accent paint layer is one of black or opaque.

9. The method of claim 5 wherein the accent paint layer is a colored paint.

10. The method of claim 5 wherein the accent paint layer is between about 25 to about 30 microns in thickness.

11. The method of claim 1 wherein a graphic design is formed in the ablation zone once the step of operating the laser is completed.

12. The method of claim 1 further comprising the step of providing a layer of hard coat material to the appearance side of the polymer substrate.

13. The method of claim 1 wherein the sacrificial material layer is at least 9 microns in thickness.

14. The method of claim 1 wherein the base paint layer is between about 12 to about 15 microns in thickness.

15. The method of claim 1 wherein the base paint layer is between about 22 to about 28 microns in thickness.

16. A vehicle panel arrangement comprising:
a body formed of polymer substrate, the body includes a painted side and a viewing side;
a sacrificial material layer adjacent the body on at least a portion of the painted side;
at least one base paint layer applied over the sacrificial material layer, and
a plurality of apertures through the at least one base paint layer and at least a portion of the sacrificial material layer such that each of the plurality of apertures form a blind hole terminating at the portion of the sacrificial material layer and the body, wherein the sacrificial material layer protects the body from damage during formation of the plurality of apertures.

17. The vehicle panel arrangement of claim 16 further comprising:
a light source for selectively projecting light toward the painted side and plurality of apertures of the body;
wherein the at least one base paint layer blocks the light transmitting through the masking layer, and
wherein light from the light source passes through the plurality of apertures, through the portion of the sacrificial material layer and the body and exits the viewing side.

18. The vehicle panel arrangement of claim 16 wherein the polymer substrate of the body is polycarbonate.

19. The vehicle panel arrangement of claim 16 wherein the sacrificial material layer is a transparent paint.

20. The vehicle panel arrangement of claim 16 further comprising an accent layer applied over the at least one base paint layer, wherein the accent layer fills in the plurality of apertures.

21. The vehicle panel of claim 16 further comprising:
a primer layer applied over the at least one base paint layer, wherein the plurality of apertures extend through the primer layer, and
an accent layer applied over the primer layer, wherein the accent layer fills in the plurality of apertures.
